(19) United States
(12) Patent Application Publication
(10) Pub. No.: US 2018/0121814 A1
(43) Pub. Date: May 3, 2018

(54) HYPERPARAMETER TUNING

(71) Applicant: Microsoft Technology Licensing, LLC, Redmond, WA (US)

(72) Inventors: Dong Yu, Bothell, WA (US); Chi Jin, Foster City, NJ (US)

(73) Assignee: Microsoft Technology Licensing, LLC, Redmond, WA (US)

(21) Appl. No.: 15/453,342

(22) Filed: Mar. 8, 2017

Related U.S. Application Data
(60) Provisional application No. 62/415,388, filed on Oct. 31, 2016.

(51) Int. Cl. G06N 5/04; G06N 99/00

(52) U.S. Cl. CPC G06N 5/04; G06N 99/005

(57) ABSTRACT

Improvements in speed and reductions in computational resource expenditure are realized in the improved tuning of hyperparameters for machine learning processes. To ensure that the values selected for hyperparameters are tuned appropriately, but quickly, several rounds of optimization are performed, each with as many or more iterations of cross-validation than prior rounds; cutting short the analysis unpromising results to devote more time and resources in analyzing promising value sets. The results are used to build suggested sets of hyperparameter values for that round, which are also cross-validated and enable the tuning process to incorporate previous operations to improve its value sets. The most promising sets of hyperparameter values from each round are selected as the basis set for the next round until a final set of values for the hyperparameters is developed.

### CROSS-REFERENCE TO RELATED APPLICATIONS

The present application claims benefit from U.S. Provisional Application No. 62/415,388, filed Oct. 31, 2016, and having the title “HYPERPARAMETER TUNING,” which is herein incorporated by reference in its entirety.

### BACKGROUND

Deep learning models have been widely used in recent years to provide predictive modeling in speech recognition systems, image classification systems, and image detection system. These deep learning models are typically associated with an algorithm for processing data and providing a predicted result. Further, for various learning models including the deep learning models, the behavior of the algorithm may be controlled through hyperparameters. More specifically, the hyperparameters may be tuned in order to optimize a models, which can significantly affect the performance of these algorithms and models.

As a result, several techniques have been developed to identify how to best tune the hyperparameters for optimizing the learning model. Popular examples of the techniques include a grid search, random search and Bayesian optimization. However, each of these techniques has drawbacks. Specifically, the grid search technique discretizes hyperparameter space with a uniform grid and chooses the best hyperparameters from the grid. However, the grid search technique is known to be slow, as it exhaustively searches through a defined hyperparameter space. Conversely, the random search technique randomly samples the hyperparameter space, evaluates the samples, and then selects the best hyperparameter that was sampled. While the random search technique is quicker than the grid search technique, the random search technique does not use information from previous evaluations. Lastly, the Bayesian optimization technique is based on a sequential optimization framework, which includes recommending a set of hyperparameters based on previous observations, training a model based on the set of hyperparameters, and repeating steps until the hyperparameters are determined. More specifically, the next hyperparameter is based on previous evaluations (i.e., (hyperparameter, error) pairs) by modeling the (hyperparameter, error) pair with a random forest model, Gaussian process, or tree-structured Parzen density estimators. Regrettably, because the Bayesian optimization is carried out as a sequential optimization problem, the Bayesian optimization has two drawbacks: the computational cost of evaluating each hyperparameter until training is finished and the overall ineffectiveness of the Bayesian optimization to deal with dimensionality.

Unfortunately, tuning hyperparameters is an increasingly difficult process that requires extensive user experience, repeated experimentation, and a tremendous amount of time and computing resources. Indeed, most machine learning models are difficult to tune because the algorithm is highly convex, there are limited amounts of data that are accessible, and the addition of noise generated by the algorithm. While these techniques work reasonably well for low dimensional small scale models, these techniques may require an unreasonable amount of time to complete training for higher dimensional models. Thus, deep learning models are very problematic because the deep learning models include numerous hyperparameters, model structures, layers, units inside each layer, kernel sizes, etc. Further, hyperparameter tuning in deep learning models typically encounters higher costs of model training per set of hyperparameters, which may take days to weeks because the deep learning models include such a large number of tunable hyperparameters. As a result of the limited amount of hyperparameters that can be trained within a limited period of time, tuning of the hyperparameters may rely on incomplete and/or limited information.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems and methods are provided herein to enable improvements in speed and reductions in the computing resources expended when tuning hyperparameters. As described herein, knowledge from previous evaluations of candidate value sets for the hyperparameters are incorporated into the analysis and growth of the candidate value sets while directing the expenditure of computing resources to those candidate value sets that are most promising.

Candidate value sets for the hyperparameters are selected and compared against a training model over several rounds of analysis. During each round, the selected value sets are evaluated against a training model and are used to develop suggested value sets in conjunction with a running knowledge of the analyzed value sets, which are also evaluated against the training model and used to update the running knowledge. At the end of each round, the most accurate value sets (whether initially selected or suggested) are selected as the value sets to be analyzed in the next round. Each successive round analyses fewer candidate value sets, but provides a greater analysis into those candidate value sets selected by further iterating their models against the training data. In this way, the analysis of unpromising candidate value sets for the hyperparameters is cut short, and the running knowledge is incorporated sooner into the tuning, thus improving the speed and efficiency of the machines used to tune hyperparameters.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example environment in which hyperparameter tuning is implemented;

FIG. 2 is a flow chart showing general stages involved in an example method for hyperparameter tuning for deep learning models;

FIG. 3 illustrates a progression in candidate value sets for hyperparameters as they are analyzed in accordance the with method illustrated in FIG. 2;

FIG. 4 is a block diagram illustrating example physical components of a computing device;

FIGS. 5A and 5B are block diagrams of a mobile computing device; and

FIG. 6 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Systems, methods, and computer readable storage media relating to a hyperparameter tuning system are provided herein. The hyperparameter tuning system is enabled to interact with a predictive learning model. The predictive learning model may include a recurrent network, feedforward network or convolution network.

The hyperparameter tuning system determines which hyperparameters relate to the predictive learning model. According to one aspect, the hyperparameter tuning system determines which hyperparameters are relevant based on parameters involved in the predictive learning model. According to another aspect, the hyperparameter tuning system determines which hyperparameters are relevant based on chaining of parameters involved in the predictive learning model. Further, the hyperparameter tuning system conveys information relating to the type of the hyperparameters. In one example, the hyperparameters behave like a uniform distribution such that if the hyperparameters are selected at a constant interval, the hyperparameters' behavior is linear, substantially linear, or operably treated as linear. In another example, the hyperparameters behave like a logarithmic distribution in which behavior may change exponentially. Accordingly, when the hyperparameter tuning system chooses a hyperparameter, the hyperparameter tuning system does not have to use a uniform or constant interval between the values. Further depending on the particular type of hyperparameter, the selected hyperparameters have continuous values and/or discrete values. For example, the layer side and number of layers may require discrete values. In contrast, hyperparameters selected in logarithmic distributions may require continuous values. Accordingly, the hyperparameter tuning system may need to try several hyperparameter combinations and observe the behavior of the predictive learning model.

The hyperparameter tuning system identifies hyperparameter value sets and compares the hyperparameter value sets against a training model. The information from previous evaluations of hyperparameter value sets are incorporated into the analysis and growth of the hyperparameter value sets while directing the expenditure of computing resources to those hyperparameter value sets that are most promising. Thus, the analysis of unpromising hyperparameter value sets is cut short, and the running knowledge is incorporated sooner into the tuning, thus improving the speed and efficiency of the machines used to tune hyperparameters.

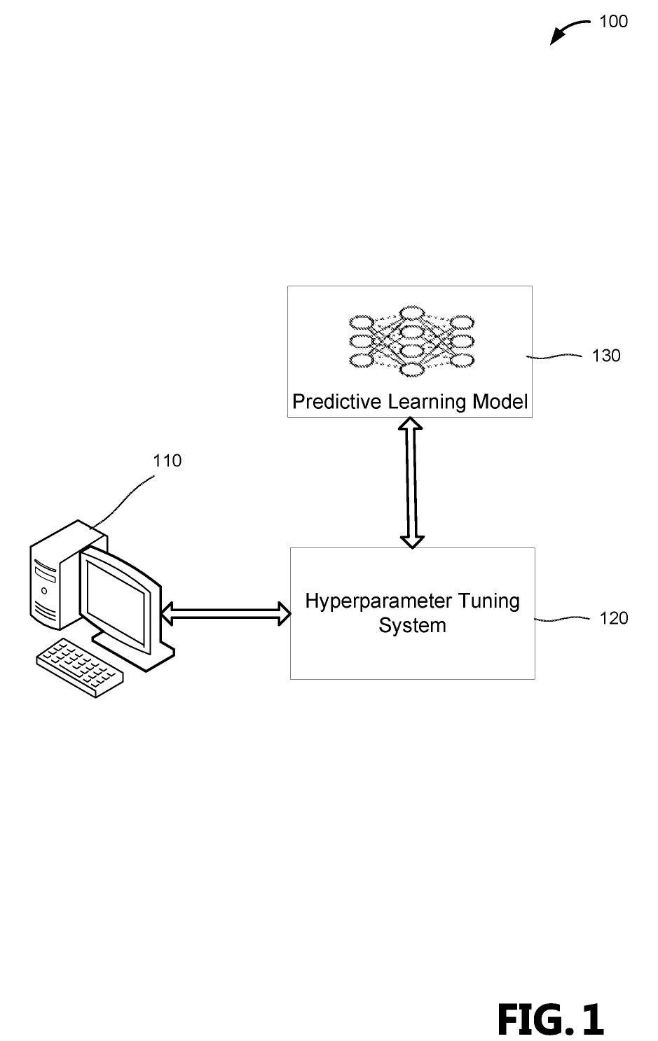

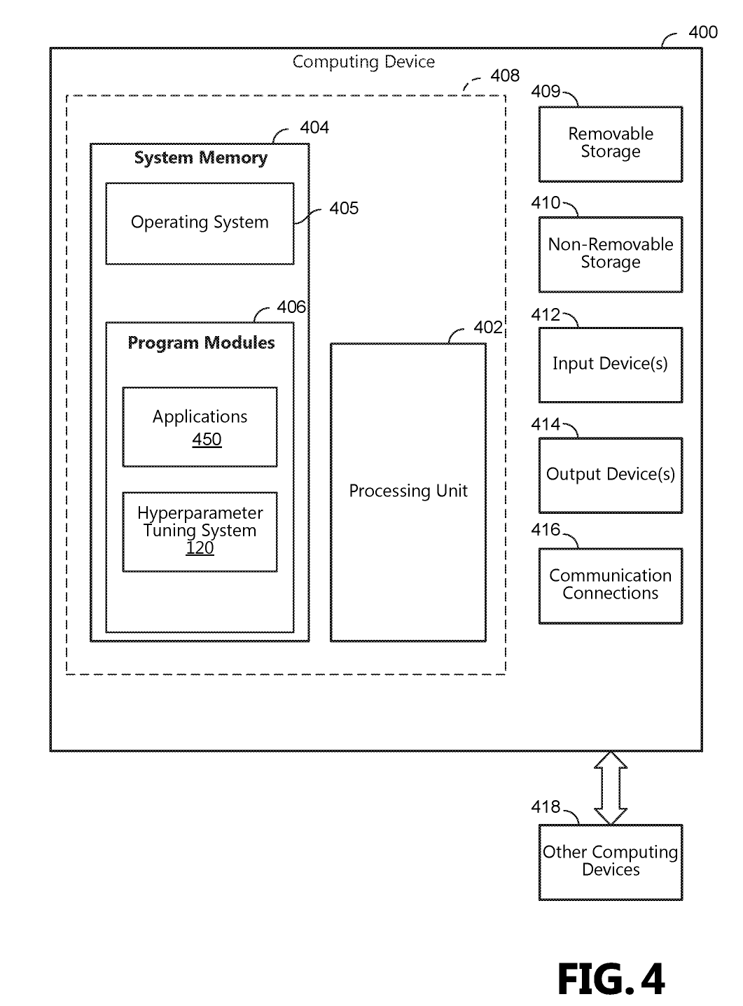

FIG. 1A is an example environment 100 in which hyperparameter tuning is implemented. The computing device 110 is illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. The hardware of these computing systems is discussed in greater detail in regard to FIGS. 4, 5A, 5B, and 6. In various aspects, the computing device 110 is accessed locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

Further, the computing device 110 communicates with a hyperparameter tuning system 120 to enable improvements in speed and reductions in the computing resources expended when tuning hyperparameters. Various intermediaries (e.g., networks and servers) may be interposed between the computing device 110 and the hyperparameter tuning system 120. Additionally, the hyperparameter tuning system 120 communicates with the predictive learning model 130 to identify hyperparameter value sets and compare the hyperparameter value sets against a training model over several rounds of analysis. During each round, the hyperparameter value sets are evaluated against a training model and are used to develop suggested hyperparameter value sets in conjunction with a running knowledge of the analyzed value sets. At the end of each round, the most accurate hyperparameter value sets are selected as the hyperparameter value sets to be analyzed in the next round. Each successive round analyses fewer hyperparameter value sets, but provides a greater analysis into those hyperparameter value sets selected by further iterating their models against the training data. In this way, the analysis of unpromising hyperparameter value sets is cut short, and the running knowledge is incorporated sooner into the tuning, thus improving the speed and efficiency of the machines used to tune hyperparameters.

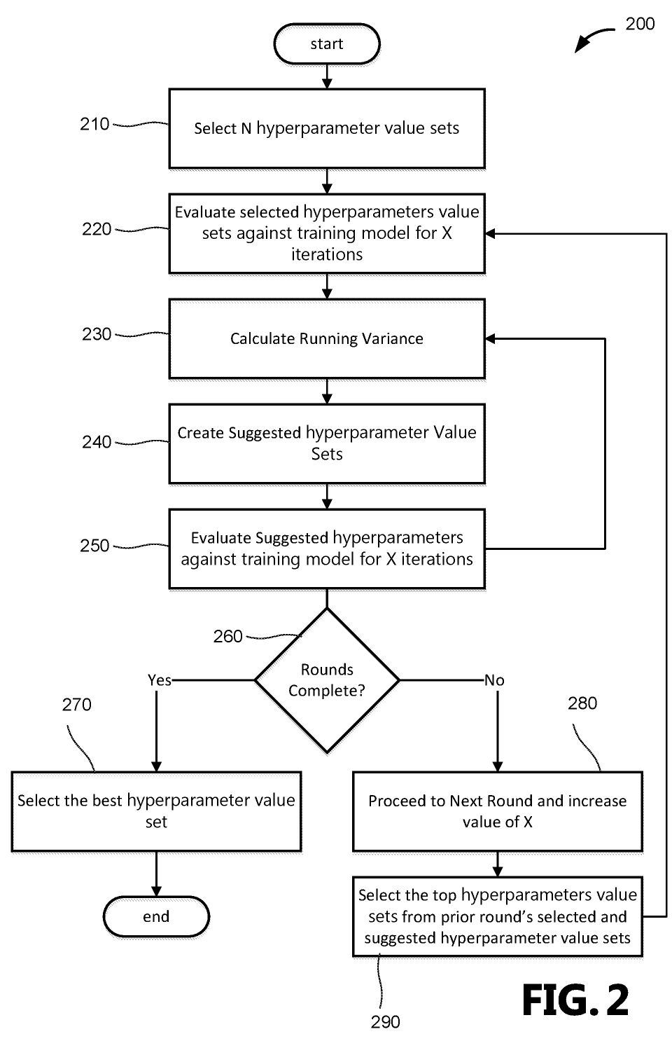

FIG. 2 is a flow chart showing general stages involved in an example method 200 of hyperparameter tuning for deep learning models.

The method 200 starts and proceeds to OPERATION 210, where the hyperparameter tuning system 120 selects hyperparameter value sets. In accordance with one aspect, the hyperparameter tuning system samples N hyperparameter value sets. In accordance with another aspect, the hyperparameter tuning system N hyperparameter value sets. In one example, when the hyperparameter tuning system 120 starts by randomly selecting hyperparameters.

The method 200 proceeds to OPERATION 220, where the hyperparameter tuning system 120 evaluates the selected hyperparameters. According to one aspect the selected hyperparameters are evaluated against a training model for a number of iterations, such as E1 epochs. The results are placed into a result set comprising the hyperparameter and the error. In other words, the hyperparameter tuning system 120 evaluates the hyperparameters for E1 epochs and places the results into the hyperparameter error test.

The method 200 proceeds to OPERATION 230, where the hyperparameter tuning system 120 calibrates. According to one aspect, the hyperparameter tuning system 120 calculates a running variance. According to another aspect, the hyperparameter tuning system 120 calibrates the system by evaluating the existing results sets, which include the hyperparameter and error pairs, and calculates the error and variance for the result sets.

The method 200 proceeds to OPERATION 240, where the hyperparameter tuning system 120 creates suggested hyperparameter value sets. According to one aspect, the hyperparameter value sets are created based on a Bayesian optimization algorithm.

The method 200 proceeds to OPERATION 250, where the hyperparameter tuning system 120 evaluates the suggested hyperparameters. According to one aspect, the selected hyperparameters are evaluated against a training model for a number of iterations, such as E1 epochs. The results are placed into a result set comprising the hyperparameter and the error. In other words, the hyperparameter tuning system 120 evaluates the hyperparameters for E1 epochs and places the results into the hyperparameter error test. Then the hyperparameter tuning system 120 selects the next hyperparameter, evaluates the hyperparameter, performs the Bayesian optimization, and then evaluates again, and continues to loop until all of the hyperparameters have been evaluated. Then if the hyperparameter tuning system 120 finishes the looping, it will go to the next round.

The method 200 proceeds to OPERATION 260, where the hyperparameter tuning system 120 determines whether additional rounds are necessary. The method 200 proceeds to OPERATION 280 where the hyperparameter tuning system 120 moves to the next round and increases the value of the iterations or epochs. If the round is necessary, the hyperparameter tuning system 120 selects the proper percentage of the hyperparameters at OPERATION 290. In one example, the percentage of the hyperparameters is 50%. Then if it performs the evaluation of the new hyperparameter value sets during the looping. Afterwards, the hyperparameter tuning system 120 determines whether additional rounds are necessary. If so, the hyperparameter tuning system 120 continues looping.

The method 200 proceeds to OPERATION 270, where the hyperparameter tuning system 120 selects the best hyperparameter. The hyperparameter tuning system 120 select the best hyperparameter based on the final result that is evaluated. The method 200 then may conclude.

According to one aspect, the relation of the hyperparameters is shown as y=ƒ(x)+ϵ, where validation error y is some hidden function ƒ and hyperparameter x plus non-deterministic noise ϵ. In one example, the hyperparameter tuning algorithm is defined by receiving inputs including an initial same size n, survival rate α, suggestion rate β, max round T, epochs {Eₜ} over t=1 to T and outputs a recommended hyperparameter x_{best}. More specifically, at S₀ a random sample of n initial sets of hyperparameters is selected. For t=1 until T, the hyperparameter tuning method trains hyperparameters in Sₜ for additional Eₜ epochs. Afterwards, the hyperparameter tuning method utilizes (additive) Bayesian Optimization to suggest β|Sₜ| new sets of hyperparameters, which are trained for E_{τ} over τ=1 to t epochs. Thereafter, the best α|Sₜ| performing sets of hyperparameters are included in the S_{τ+1} hyperparameters set. Additionally, the hyperparameter tuning method calibrates and validates any errors against the hyperparameters at the stopped E_{τ} epochs. As a result, the hyperparameter tuning method returns the best performing x_{best} in S_{T}. It should also be recognized that the parameters of the hyperparameter tuning method may be weighted to adjust the factors in hyperparameter selection. For example, in one example implementation, the initial sample size n=96, survival rate α=3/8, suggestion rate β=1/3, max around T=4, and list E_{τ} over τ=1 to t epochs as 2, 4, 8, and 16. As discussed above, the hyperparameter tuning method randomly samples the initial sample size and trains the hyperparameters for two epochs. Based on the results, the hyperparameter tuning method recommends 32 sets of hyperparameters (96/3) and trains for two epochs for a total of 128 sets of hyperparameters. Thereafter, the hyperparameter tuning method selects the best performing 3/8 of the hyperparameters sets and discards the lesser performing hyperparameters sets.

According to another aspect, the optimization of the hyperparameters may be implemented by a Bayesian optimization framework or as a Gaussian model, such as:

[symbol]

(y|f)= [symbol] (f,(αβ)²I),P(f)= [symbol] (m1,α²K_{ƒ}),[K_{ƒ}]ᵢⱼ=K(xᵢ,xⱼ).

In the example model, K(⋅, ⋅) is the kernel function, m is a mean prior to the function value, α is the kernel amplitude, and β is the observed noise factor. Further, because probabilistic inference, [symbol] (f̅|y)= [symbol] (\hat{μ},\hat{σ}²) where:

\tilde{μ}=m+k¹K_{y}⁻¹(y−m1)

\tilde{σ}²=α²(K_{ƒ̅}−k^{T}K_{y}⁻¹k)

Further, when considering the distance of τ in calculation of the automatic relevance determination, the kernel function may be represented as:

$${r}^{2} ( x , {x}^{′} ) = {\sum }_{i = 1}^{d} {γ}_{i}^{2} \cdot {dist}^{2} ( {x}_{i} , {x}_{i}^{′} )$$

The kernel function may be implemented as a squared exponential (SE) kernel or a Matern 5/2 kernal. As a result, according to one aspect, the acquisition function for selection of the hyperparameters is implemented with or without consideration of the additive process. In one example, the acquisition function is implemented as an upper confidence bound (e.g., α_{UCB}(\hat{x})=−\hat{μ}+λ\hat{σ}) or via an expected improvement function (e.g. α_{EI}(\tilde{x})=\tilde{σ}·[δ·normedf(δ)+normpdf(δ)]) to improve upon the best performing x_{best}. Furthermore, the acquisition function may incorporate additive structure to reduce the effect associated with dimensionality of the hyperparameter tuning. Accordingly, the additive upper confidence bound function (e.g., α_{UCB}⁽ⁱ⁾(\tilde{x}⁽ⁱ⁾)=−\tilde{μ}⁽ⁱ⁾+λ\tilde{σ}⁽ⁱ⁾) allows for optimization of the hyperparameters within each group.

According to another aspect, the selection of the hyperparameters may be implemented by a Gaussian process. In one example, the process may be observed by a marginal negative logarithmic likelihood, which is represented as:

$$- log ℙ ( y \vert X , θ ) = \frac{1}{2 {α}^{2}} {( y - m 1 )}^{T} {K}_{y}^{- 1} ( y - m 1 ) + \frac{1}{2} log det ( {K}_{y} ) + \frac{n}{2} log {α}^{2} + \frac{n}{2} log 2 π$$

It should be recognized that θ denotes all of the Gaussian process hyperparameters. Further, the marginal negative logarithmic likelihood may be modified to define a maximum likelihood estimation (MLE) by providing a closed-form for the constant mean (m) and kernel amplitude (α²), such as shown below:

$$\hat{m} = \frac{{1}^{T} {K}_{y}^{- 1} y}{{1}^{T} {K}_{y}^{- 1} 1} {\hat{α}}^{2} = \frac{{( y - m 1 )}^{T} {K}_{y}^{- 1} ( y - m 1 )}{n}$$

Further, based on the selection of the squared exponential kernel or the Matern 5/2 kernel, the feature scaling may differ. In either situation, the hyperparameters are set by maximizing the log [symbol] (y|X,θ) using a local search algorithm (e.g., a conjugate gradient algorithm). Example functions illustrating the feature scaling associated with the squared exponential kernel (K_{SE}) or the Matern 5/2 kernel (K_{M52}) are shown below.

$$\frac{\partial K ( x , {x}^{′} )}{\partial {γ}_{i}} = - {K}_{SE} ( x , {x}^{′} ) \cdot {γ}_{i} \cdot {dist}^{2} ( {x}_{i} , {x}_{i}^{′} )$$

$$\frac{\partial K ( x , {x}^{′} )}{\partial {γ}_{i}} = \frac{5 + 5 \sqrt{5} r}{3 + 3 \sqrt{5} r + 5 {r}^{2}} \cdot {K}_{M 52} ( x , {x}^{′} ) \cdot {γ}_{i} \cdot {dist}^{2} ( {x}_{i} , {x}_{i}^{′} )$$

With respect to setting the observed noise β, the functions may vary based on the amount of noise. In one example, when the noise is small then β² is set to make K_{y} matrix well-conditioned, for example:

$${\hat{β}}^{2} = \frac{{λ}_{max} ( {K}_{f} )}{{10}^{6}}$$

However, when the noise is large, a gradient descent may be used. For example, the gradient descent may be demonstrated as:

$$\frac{\partial {K}_{y}}{\partial β} = 2 β I$$

While the above examples are provided for demonstrative purposes of an implementation, it is to be understood that the following detailed description is explanatory only and is not restrictive of the claims.

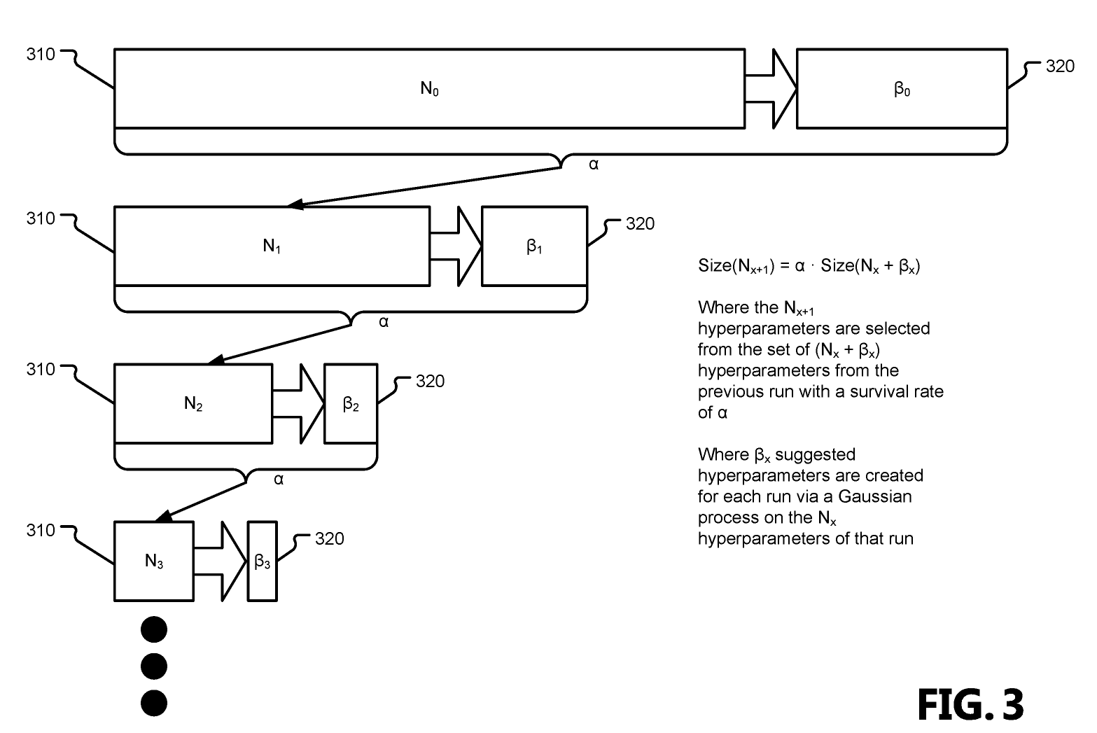

FIG. 3 illustrates a progression in candidate value sets for hyperparameters as they are analyzed in accordance with method 200. As illustrated, a collection of selected value sets 310 is selected for use in an each round (rₓ) to produce a collection of suggested value sets 320, where the number of selected value sets is noted as Nₓ and the number of suggested value sets is noted as βₓ. Although four rounds are illustrated in FIG. 3, it will be appreciated that in different aspects, more or fewer rounds of analysis may be performed.

Both the collection of selected value sets 310 and the collection of suggested value sets 320 are evaluated against the training data each round, and are used to maintain a running calculation for their variance (e.g., an error rate and hyper parameter cross-correlation) from the training data. The running calculation is used to produce the collections of suggested value sets 320 of the course of several rounds, which are selected via a probabilistic process to attempt lower error rates when compared against the training data.

Once the collection of selected value sets 310 and the collection of suggested value sets 320 are evaluated for a given round, the number of value sets is reduced according to a survival rate α for the next round. The survival rate α defines a number of hyperparameter sets that will be selected from those evaluated in the prior round so that the size of the collection of selected value sets 310 for the next round rₓ₊₁ will be equal to α·Quantity(Nₓ+βₓ).

For example, where N₀ is equal to 96, βₓ one third of Nₓ (32 for β₀ in the present example), and α is equal to 3/8 (0.375), N₃ would be equal to twelve. In various aspects, as will be appreciated, the ratios α and of βₓ to Nₓ and will differ from those given in the above example, and may remain constant between rounds or change.

As described in association with method 200 above, early stopping with a recommender provides several advantages to systems tuning hyperparameters related to machine learning models for data processing. By successively reducing the number of candidate value sets evaluated, computing resources are conserved for evaluating the most promising candidate value sets. In addition to the initially selected value sets, based on the performance of those selected sets, several additional configurations for candidate value sets are suggested via, for example, a Gaussian process. The candidate value sets from the selected and the suggested value sets that performed best in relation to the training data for the machine learning model are then selected for further analysis and development of further suggested value sets. In various aspects, the percentages of selected and suggested value sets for a given round may vary, as can the duration of iterations for each round, the number of rounds, and the number of value sets evaluated in each round.

As described in association with method 200 above, a Gaussian process is used in some aspects to develop suggested value sets, although other probabilistic or statistical models may be used. For a Gaussian process, several points of data, (xᵢ, yᵢ), are observed to perform a regression for the function where yᵢ=f(xᵢ) to predict the mean and variance of the differences of the value sets against the training models.

When using a Gaussian process, for f(xᵢ) to f(xₙ), n vectors are produced in a Gaussian distribution where the mean is a constant m (illustrated as the center of a “bell curve”). The variance and means are used in conjunction with a kernel matrix to identify the correlation between different hyperparameters. So if two hyperparameters are strongly correlated, values sets with similar values for those hyperparameters, are expected to have similar error rate when observed against the training data. Conversely, if two hyperparameters are weakly or not correlated, it is expected that values sets with similar values for those hyperparameters would have observed error rates that would diverge or be unrelated, with little to no correlation to each other. These data are used to estimate a new a value for a hyperparameter in a suggested value set that is expected to have a lower error rate based on prior observations and the strengths and correlations of hyperparameters on the error rate.

The kernel, in various aspects include a squared exponential kernel and/or a Matern kernel, and is used as a covariance function with the Gaussian distribution function to optimize the function f(x), to find the values that will minimize the error rate when the hyperparameters are tested against the training data. These acquisition functions are simpler to calculate, and easier to optimize, than the model using all of the hyperparameters, and allow for rapid turnaround and successive testing. These acquisition functions include confidence functions for the selection of new values as to whether those values will affect the results of the value sets relative to their error rates and functions to predict how large the effect is predicted to be.

The variances are used to select new values for the hyperparameter sets and are maintained as a running calculation so that as the round progresses, the calculations for the kernel are incorporated into future runs of the acquisition functions to produce successively more accurate suggested value sets for the hyperparameters (i.e., with lower expected variance from the training data).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes hyperparameter tuning system 120. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 (e.g., hyperparameter tuning system 120) perform processes including, but not limited to, one or more of the stages of the method 200 illustrated in FIG. 2. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

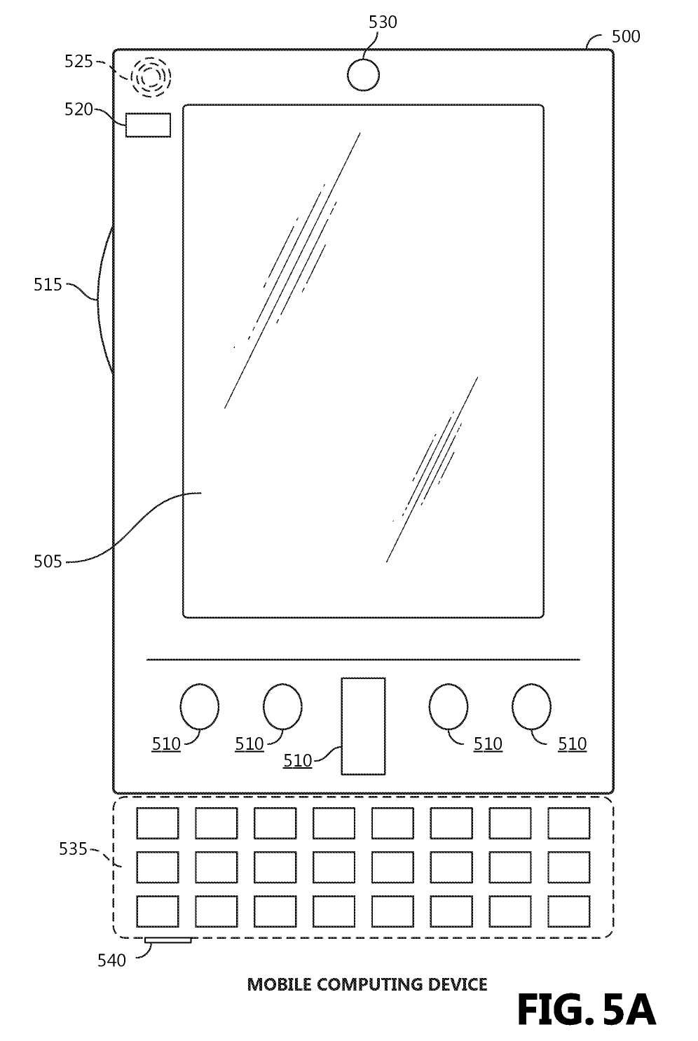

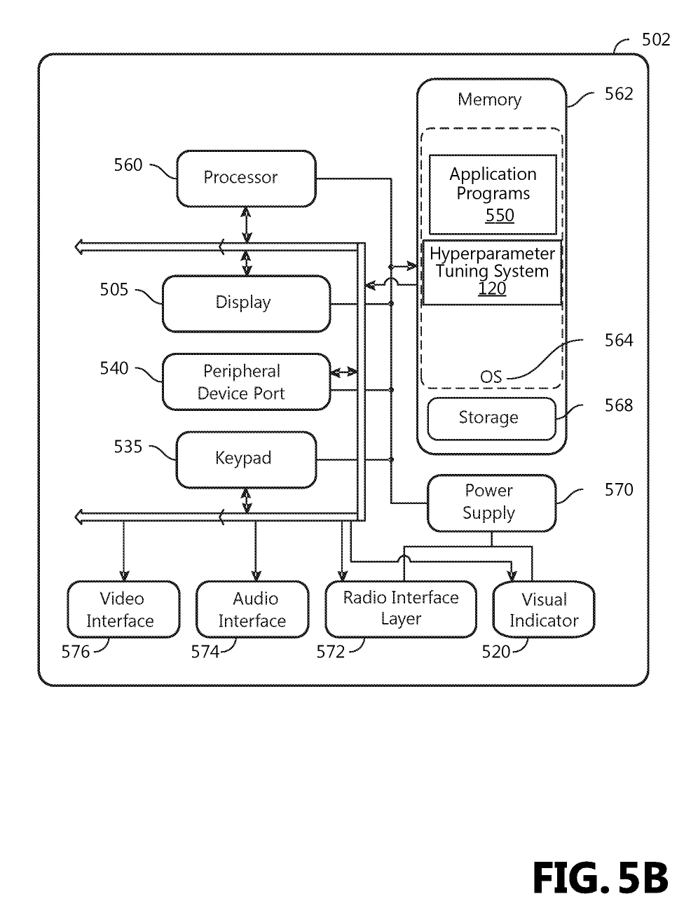

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or fewer input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, hyperparameter tuning system 120 is loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 are stored locally on the mobile computing device 500, as described above. According to another aspect, the data are stored on any number of storage media that are accessible by the device via the radio 572 or via a wired connection between the mobile computing device 500 and a separate computing device associated with the mobile computing device 500, for example, a server computer in a distributed computing network, such as the Internet. As should be appreciated such data/information are accessible via the mobile computing device 500 via the radio 572 or via a distributed computing network. Similarly, according to an aspect, such data/information are readily transferred between computing devices for storage and use according to well-known data/information transfer and storage means, including electronic mail and collaborative data/information sharing systems.

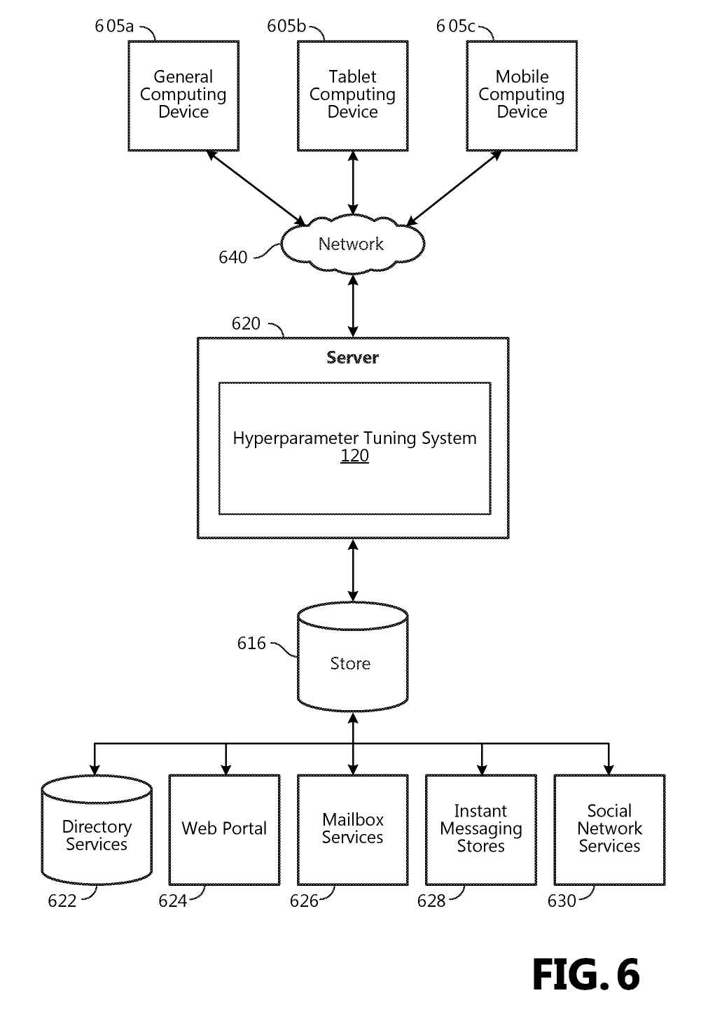

FIG. 6 illustrates one example of the architecture of a system for improved hyperparameter tuning as described above. Content developed, interacted with, or edited in association with the hyperparameter tuning system 120 is enabled to be stored in different communication channels or other storage types. For example, various documents may be stored using a directory service 622, a web portal 624, a mailbox service 626, an instant messaging store 628, or a social networking site 630. The hyperparameter tuning system 120 is operative to use any of these types of systems or the like for improving hyperparameter tuning, as described herein. According to an aspect, a server 620 provides the hyperparameter tuning system 120 to clients 605a,b,c. As one example, the server 620 is a web server providing the hyperparameter tuning system 120 over the web. The server 620 provides the hyperparameter tuning system 120 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for providing hyperparameter tuning relating to a predictive learning model, comprising:
identifying a number of rounds to perform the hyperparameter tuning evaluations;
performing hyperparameter tuning evaluations for the identified number of rounds, each round of the hyperparameter tuning evaluations including the steps of:
retrieving a selected number of hyperparameter value sets;
evaluating the selected hyperparameter value sets against a training data for the predictive learning model for a selected duration;
creating suggested hyperparameter value sets;
evaluating the suggested hyperparameters value sets against the training data for the predictive learning model for the selected duration;
increasing the selected duration; and
selecting a number of hyperparameter value sets from the selected hyperparameter value sets and the suggested hyperparameter value sets; and
after performing the hyperparameter tuning evaluations for the identified number of rounds, selecting the best hyperparameter value set.

2. The method of claim 1, wherein the number of rounds is based on a number of hyperparameters to evaluate.

3. The method of claim 1, wherein the selected duration includes two iterations of evaluating the selected hyperparameter value sets and the suggested hyperparameters value sets against a training data for the predictive learning model.

4. The method of claim 3, wherein the selected duration increases linearly.

5. The method of claim 3, wherein the selected duration increases exponentially.

6. The method of claim 1, wherein the number of rounds is based on a temporal factor for identifying a finalist grouping of hyperparameters.

7. The method of claim 1, wherein the number of rounds is based on a temporal factor for identifying a finalist grouping of hyperparameters.

8. The method of claim 1, wherein the number of rounds is based on a confidence of each of the hyperparameters identified in a finalist grouping of hyperparameters.

9. The method of claim 1, wherein selecting the number of hyperparameter value sets from the selected hyperparameter value sets and the suggested hyperparameter value sets further comprises selecting a specified percentage of the hyperparameter value sets.

10. A system for providing hyperparameter tuning relating to a predictive learning model, comprising:
a processing unit; and
a memory including computer readable instructions, which when executed by the processing unit, causes the system to be operable to:
receive a selection of hyperparameters;
identify a number of rounds to perform the hyperparameter tuning evaluations;
perform hyperparameter tuning evaluations for the identified number of rounds, each round of the hyperparameter tuning evaluations including the steps of:
retrieving a selected number of hyperparameter value sets;
evaluating the selected hyperparameter value sets against a training data for the predictive learning model for a selected duration;
creating suggested hyperparameter value sets;
evaluating the suggested hyperparameters value sets against the training data for the predictive learning model for the selected duration;
increasing the selected duration; and
selecting a number of hyperparameter value sets from the selected hyperparameter value sets and the suggested hyperparameter value sets; and
select the best hyperparameter value set after the hyperparameter tuning evaluations for the identified number of rounds was performed.

11. The system of claim 10, wherein the number of rounds is based on a number of hyperparameters to evaluate.

12. The system of claim 10, wherein the selected duration includes two iterations to evaluate the selected hyperparameter value sets and the suggested hyperparameters value sets against a training data for the predictive learning model.

13. The system of claim 12, wherein the selected duration increases linearly.

14. The system of claim 12, wherein the selected duration increases exponentially.

15. The system of claim 10, wherein the number of rounds is based on a temporal factor for identifying a finalist grouping of hyperparameters.

16. The system of claim 10, wherein the number of rounds is based on a temporal factor for identifying a finalist grouping of hyperparameters.

17. The system of claim 10, wherein the number of rounds is based on a confidence of each of the hyperparameters identified in a finalist grouping of hyperparameters.

18. The system of claim 10, wherein selecting the number of hyperparameter value sets from the selected hyperparameter value sets and the suggested hyperparameter value sets further comprises selecting a specified percentage of the hyperparameter value sets.

19. A computer readable storage device including computer readable instructions, which when executed by a processing unit, performs steps for providing hyperparameter tuning relating to a predictive learning model, comprising:
receiving a selection of hyperparameters;
identifying a number of rounds to perform the hyperparameter tuning evaluations based on the selection of hyperparameters;
performing hyperparameter tuning evaluations for the identified number of rounds, each round of the hyperparameter tuning evaluations including the steps of:
retrieving a selected number of hyperparameter value sets;
evaluating the selected hyperparameter value sets against a training data for the predictive learning model for a selected duration;
creating suggested hyperparameter value sets;
evaluating the suggested hyperparameters value sets against the training data for the predictive learning model for the selected duration;
increasing the selected duration, wherein the selected duration increases linearly; and
selecting a number of hyperparameter value sets from the selected hyperparameter value sets and the suggested hyperparameter value sets, wherein the selecting a specified percentage of the hyperparameter value sets; and
after performing the hyperparameter tuning evaluations for the identified number of rounds, selected the best hyperparameter value set.

20. The computer readable storage device of claim 19, wherein the selected duration includes two iterations of evaluating the selected hyperparameter value sets and the suggested hyperparameters value sets against a training data for the predictive learning model.
